(19) United States
(12) Patent Application Publication
(10) Pub. No.: US 2007/0233659 A1
(43) Pub. Date: Oct. 4, 2007

(54) Information auto classification method and information search and analysis method

(75) Inventor: Jeong Joong Kim, Suwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/540,678

(22) Filed: Oct. 2, 2006

Related U.S. Application Data
(63) Continuation-in-part of application No. 10/227,283, filed on Aug. 26, 2002.
Application No. 10/227,283 is a continuation-in-part of application No. 09/316,039, filed on May 21, 1999, now abandoned.

(30) Foreign Application Priority Data
May 23, 1998 (KR) 10-1998-0018689

(51) Int. Cl. G06F 17/30

(52) U.S. Cl. 707/3

(57) ABSTRACT

A method for searching information, which includes accessing an information source online or offline, the information source including a number of plurality of selectable fields, selecting and extracting specific fields that satisfy a search condition from the information source, and grouping and displaying contents of the extracted specific fields with reference to time on an X axis and technology classification on a Y axis.

This application is a Continuation-In-Part application of U.S. application Ser. No. 10/227,283 filed on Aug. 26, 2002, the entire content of which is incorporated by reference in its entirety.

### BACKGROUND OF THE INVENTION

1. Field of the Invention

The present invention relates to an information search system, which allows a user to effectively confirm and analyze information/data items retrieved from a variety of information sources such as patent data, article data, or technical data, and a method for displaying information retrieved by the information search system.

2. Description of the Background Art

When building an information database such as a patent information database, a user generally accesses a CD-ROM, etc. containing patent information to search for certain information. Thereafter, the user searches for desired information and processes the information to correspond with a separate database maintained by the user. That is, the user must manually enter items from the processed patent information into his or her own database. This is a time-consuming process.

In addition, the processed patent information data is output in a predetermined format, which differs from the format of the user's database. That is, the output conditions of the processed patent information data is limited. Therefore, the user must manually enter data from the displayed patent information data to his her database. Further, previous search conditions and results are not readily available to the user when performing a new search.

Also, the searched information is displayed to the user in a limited fashion. Therefore, the user must scroll or page through the displayed information to analyze all of the processed information. This also is time consuming.

### SUMMARY OF THE INVENTION

Accordingly, one object of the present invention is to address the above-noted and other objects.

Another object of the present invention is to provide an information classification method that automatically classifies information stored in an information source to correspond with a database of a user.

Yet anther object of the present invention is to provide a method for effectively searching and analyzing information using a variety of different search conditions and for displaying the searched information to the user.

To achieve the above objects, the present invention provides in one aspect a method for searching information, which includes accessing an information source online or offline, the information source including a number of plurality of selectable fields, selecting and extracting specific fields that satisfy a search condition from the information source, and grouping and displaying contents of the extracted specific fields with reference to time on an X axis and technology classification on a Y axis.

In another aspect, the present invention provides an information search system including an accessing mechanism configured to access an information source online or offline, the information source including a number of plurality of selectable fields, a selecting and extracting mechanism configured to select and extract specific fields that satisfy a search condition from the information source, and a grouping and displaying mechanism configured to group and display contents of the extracted specific fields with reference to time on an X axis and technology classification on a Y axis.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flowchart illustrating a method for searching, classifying and storing information according to an embodiment of the present invention;

FIG. 2 is a block diagram illustrating a network of an integrated database system according to an embodiment of the present invention;

FIG. 3 is an overview illustrating a format of data stored in a hard disk drive (HDD) for the system of FIG. 2;

FIG. 4 is a flowchart illustrating an information data search method according to an embodiment of the present invention;

FIGS. 5A and 5B are overviews illustrating initial windows used to log onto an integrated information management system via a web browser according to an embodiment of the present invention;

FIGS. 6A and 6B are overviews illustrating initial windows when a user has successfully logged onto the system according to an embodiment of the present invention;

FIGS. 7A and 7B are overviews illustrating a patent search menu window according to an embodiment of the present invention;

FIG. 8 is a flowchart illustrating a method of analyzing information data according to an embodiment of the present invention;

FIGS. 9A-9B and 10A-10B are overviews illustrating tree map type windows resulting from an information data analysis according to an embodiment of the present invention;

FIGS. 11A and 11B are overviews illustrating a pie chart window resulting from an information data analysis according to an embodiment of the present invention;

FIGS. 12A, 12B and 12C are overviews illustrating a trend map window resulting from an information data analysis according to an embodiment of the present invention;

FIGS. 13A, 13B and 13C are overviews illustrating a bar map window resulting from an information data analysis according to an embodiment of the present invention;

FIGS. 14A, 14B, 14C and 14D are overviews illustrating another pie map window resulting from an information data analysis according to an embodiment of the present invention;

FIGS. 15A, 15B and 15C are overviews illustrating a window of detailed patent information data according to an embodiment of the present invention;

FIGS. 16A and 16B are overviews illustrating a window of magnified detailed patent drawing information data;

FIG. 17 is a flowchart of a method for displaying search information according to the present invention;

FIG. 18 is an X-Y dimensional graph illustrating data items displayed on a screen according to an embodiment of the present invention; and

FIG. 19 is an overview illustrating more detailed information of a data item displayed on a screen according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

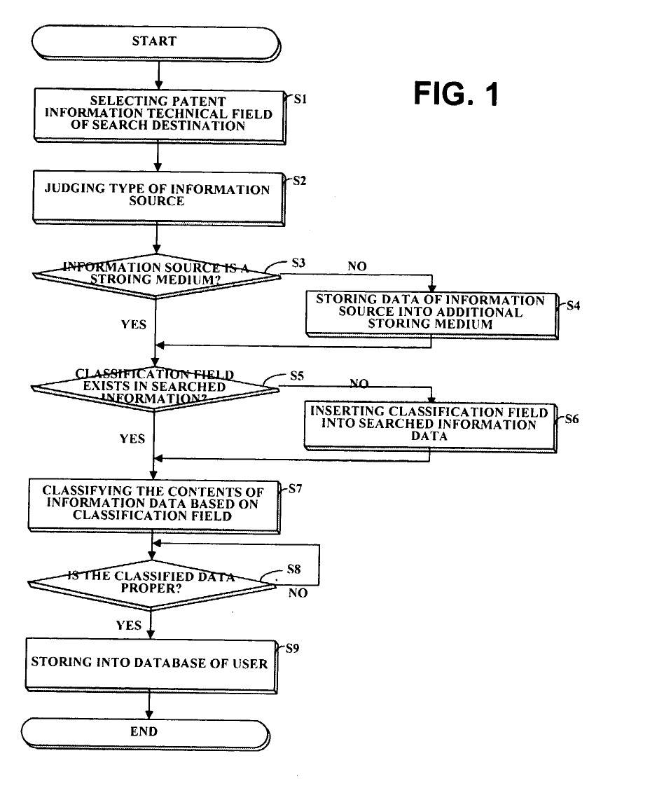

First, FIG. 1 is a flowchart illustrating an information classification method according to the present invention. As shown, a user first selects a certain patent technical field that he or she wants to search (Step S1). Then, in step S2, the user determines an information source type which is used for the search. Namely, the user determines whether the information source is an external patent information database accessed via the Internet or communication network, for example, or an internal patent information database such as a CD ROM, optical file, magnetic tape, etc. containing patent information.

If the information source is an external database or an information source which is not compatible to the database of the user (Yes in Step S3), the information stored in the external database is copied or downloaded and stored onto a storing medium connected with the database of the user (Step S4). However, if the information source is an internal database (Yes in Step S3), the data does not have to be downloaded.

Next, in step S5, the user determines whether the classification field he or she wants is in the information source. If the field is not there (No in Step S5), the user reviews the information to determine if a similar classification field exists or selects another search classification field (Step S6). The classification field is referred to as a field for classifying the data in the information source. For example, the classification field may be the object of the invention, an embodiment or embodiments, advantages, claims an abstract, drawings, an IPC (International Patent Classification) number, an application number, a publication number, a patent serial number, etc.

Then, in Step S7, an information classification program programmed to make the information compatible with the database of the user, automatically classifies the information using the classification field(s) entered by the user. The user then determines whether the data of the classified information is reliable (Step S8), and stores the classified information in the database if the data is reliable (Yes in Step S8).

The information classification program may be programmed by the user. For example, when the information source has image information and text information, the program is programmed to classify and store the image information and the text information. In addition, if the information source includes only text information, the image information may be stored to be compatible with the database via the copy or download operation.

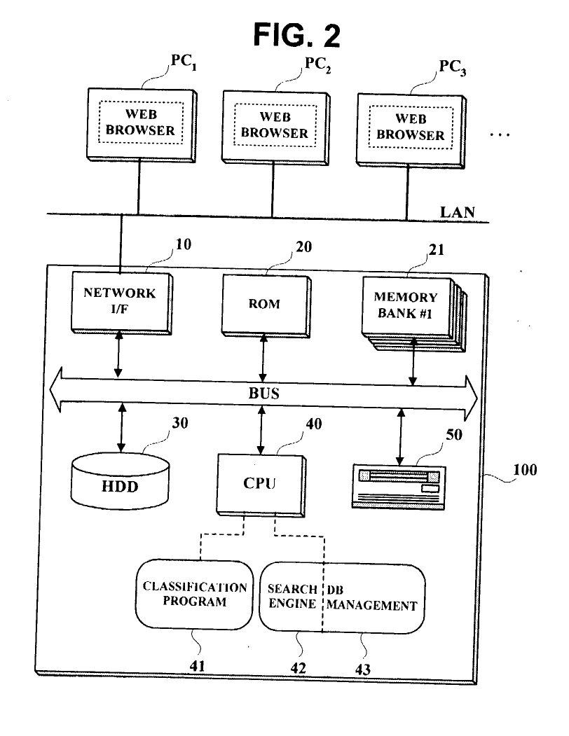

Turning next to FIG. 2, which is a block diagram of a network for an integrated database system according to an embodiment of the present invention. As shown, the system includes a search server 100 connected to a plurality of a search terminals PC1, PC2, . . . , via a network. The system also includes a ROM 20 for storing a system initialization program and O/S driving program, a memory bank 21, and a central processing unit (CPU) 40. A classification program 41 to be run by the CPU 40 is first loaded into the memory bank 21. The CPU 40 then runs the program 41 for classifying, storing and searching the information data. Also included is a hard disk drive (HDD) 30 that stores the classified information and also contains a classification/search program. Further, a CD ROM drive 50 is used for receiving an internal CD ROM having patent information.

The process of searching and classifying information from the information source using the system shown in FIG. 2 will now be described. First, the information source (i.e., the CD ROM in this example) is inserted into the CD ROM drive 50, and the system loads certain information from the HDD 30 into the memory bank 21. The CPU 40 then runs the classification program 41 to perform a classification operation with respect to the information sequentially read from the CD ROM. Namely, the classification program 41 selects at least one classification field depending on whether the classification field is present in the information read from the CD disk.

When a classification field is selected, the classification program 41 detects words or sentences having specific patterns based on the selected classification field and classifies the information with reference to the detected words or sentences. For example, Korean patents with abstracts are classified such that the abstract is classified as an object item and the first claim is classified as a solution item. In addition, Korean patents without abstracts are classified such that the first sentence in the first claim is classified as an object item and the remaining sentences thereof are classified as a solution item. Such classified information can then be analyzed by the user.

In addition, an “object of the invention” field of an abstract in Japanese patent information has a specific pattern including a “TO” sentence and a “BY” sentence. Taking this fact into consideration, the Japanese patent information is classified such that the “TO” sentence is classified as an object item and the “BY” sentence is classified as a solution item. Further, United States patent information is classified such that the first sentence in the abstract is classified as an object item and the remaining sentences thereof are classified as a solution item. That is, the first sentence of the abstract is classified as the problem to be overcome, and the remaining sentences of the abstract are classified as the solution to overcome the problems (i.e., the problem resolving members).

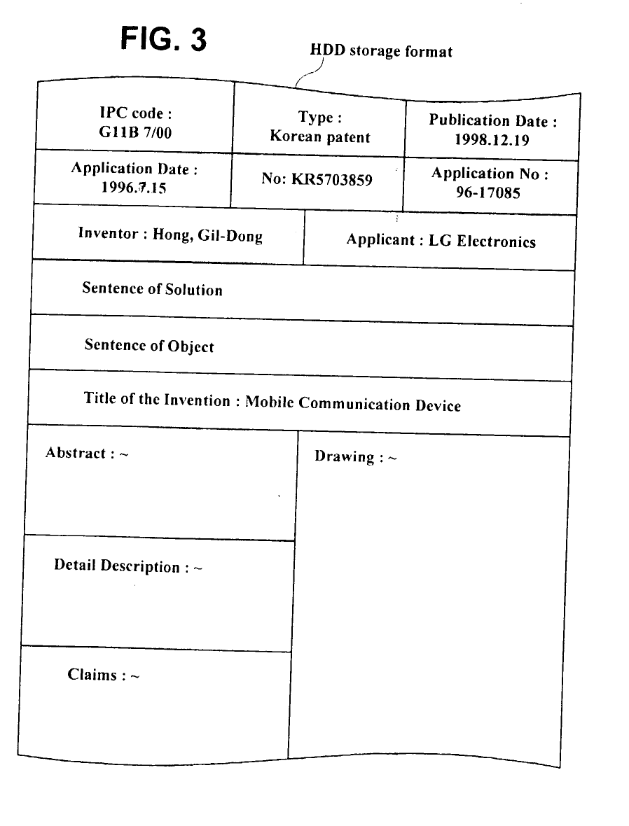

Therefore, the problems to be overcome and the solutions are extracted, classified and arranged as patent information data in a format as shown in FIG. 3, for example. As shown in FIG. 3, the patent information data includes a IPC code, a Type of patent (e.g., Korean, US, etc.), a Publication date, Application date, Patent number (e.g., KR5703859), Inventor information, Assignee or Applicant information, Solution, Object, Title, Abstract, Detailed Description, Claims and Drawings. FIG. 3 is an example only and other data formats can be used.

Further, the patent information data is stored on the HDD 30. Also, the classification program 41 performs the above-explained extraction and classification operations for object-related sentences (i.e., the sentences associated with the “object of the invention” field) of all patent information data read from the CD ROM disk, so that all patent data stored in the disk is placed in the format as shown in FIG. 3. The data items are then separately stored into corresponding storing regions of the HDD 30, thereby establishing a desired database for integration with the information management system according to an embodiment of the present invention.

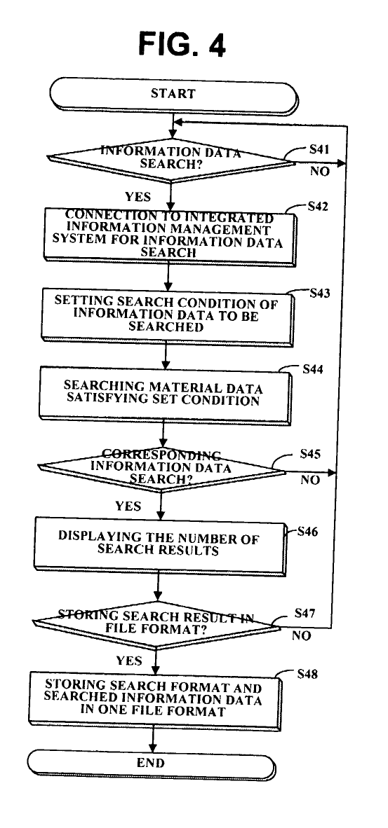

Turning next to FIG. 4, which is a flowchart illustrating a method of searching for information according to an embodiment of the present invention. FIG. 2 will also be referred to in this description.

As shown in FIG. 4, when the user wants to search for patent information data from the database of the integrated information management system (Step S41), the user executes the web browser installed at a search terminal PC and accesses the search server 100 including the integrated information management database (DB) (Step S42).

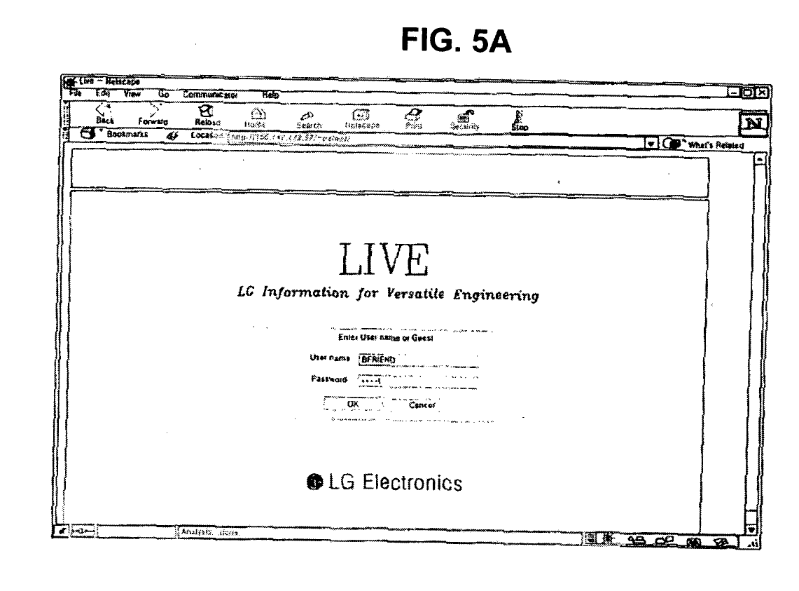

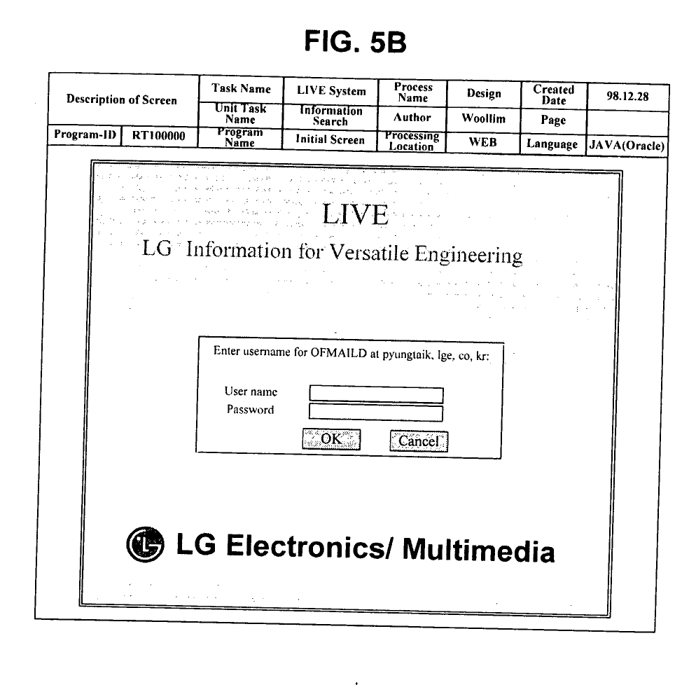

When the user connects to the integrated management system, the user is prompted with a log on screen as shown in FIG. 5A or 5B, for example. Here, the user is prompted to enter a user name and password. Upon a successful log on, the server 100 loads the search engine 42 and DB management program 43 from the HDD 30 to the memory bank 21 and executes the search engine 42 and DB management program 43. Further, the search engine 42 is a program for searching and analyzing information.

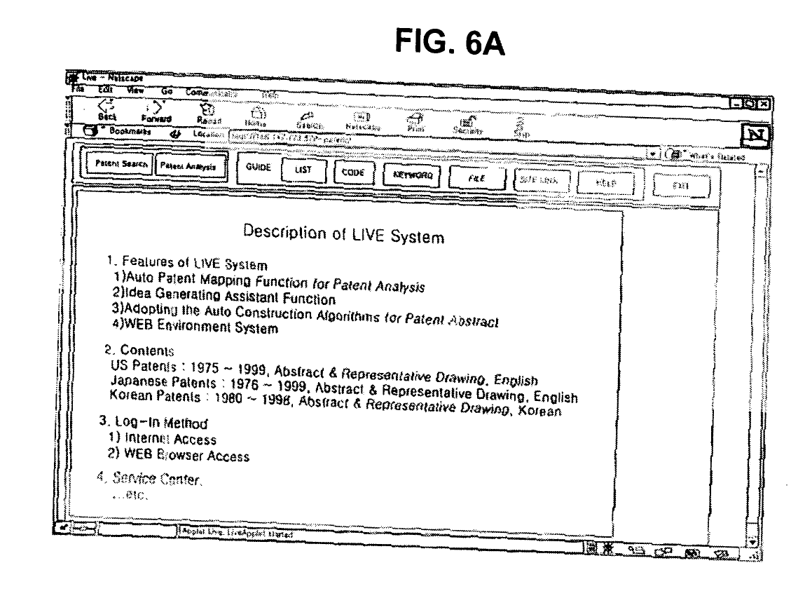

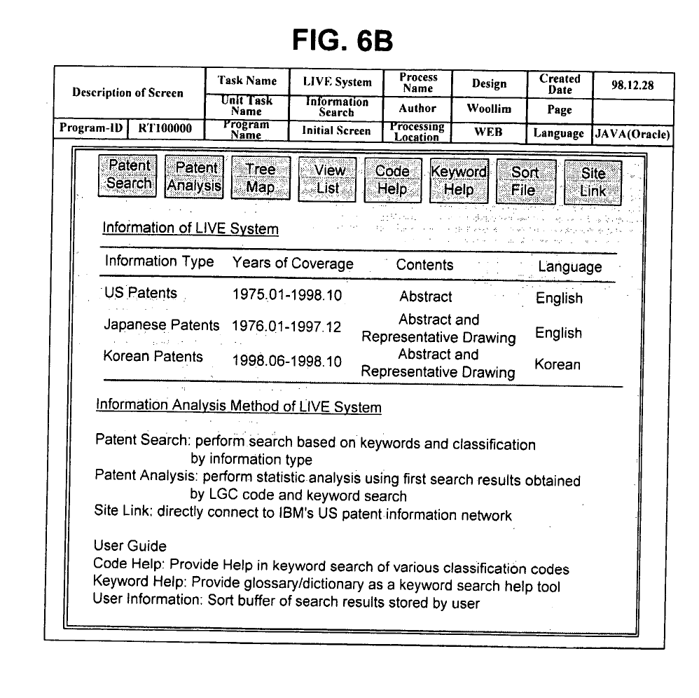

Then, the search engine 42 downloads a JAVA applet contained in the integrated information management system into the search terminal via the network interface 10. Thus, after successfully logging on the system, the user is prompted with a screen as shown in FIG. 6A or 6B, for example. As shown, FIGS. 6A and 6B provide an overview of the system. For example, the user can select the “Patent Search” option from the toolbar shown in FIGS. 6A and 6B to perform a desired patent search.

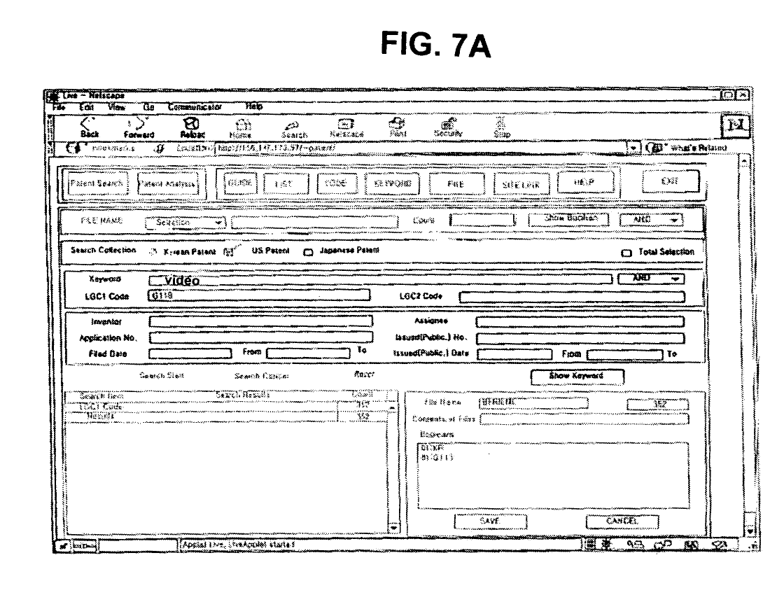

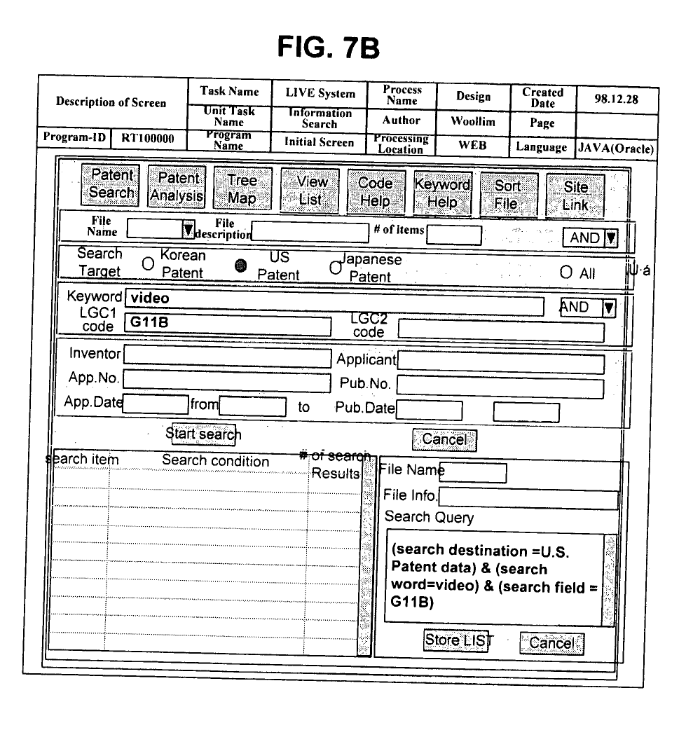

In addition, when the user selects the “Patent Search” option, he or she is provided with a patent search menu including a variety of fields that may be used to search for particular patent information. The patent search menu is displayed under control of the integrated information management search server 100. FIGS. 7A and 7B illustrate examples of patent search menus according to an embodiment of the present invention.

Therefore, with reference to FIG. 4, the user can then input information into the patent search menu shown in FIG. 7A or 7B to begin searching for desired information (Step S43). For example, the user can select whether Korean, US and/or Japanese patents are searched, and can search by inventor, application, keyword or search term, a technical classification code or IPC, filed date, etc. As shown in FIGS. 7A and 7B, U.S. patents are selected, the technical classification is set at G11B, and the search term “Video” is input.

The search engine 42 then builds a query with respect to the values entered by the user, and transfers the query to the DB management program 43 stored in the memory bank 21. The DB management program 43 then searches the HDD 30 for information/data corresponding to the query received from the search engine 42 (Step S44). In more detail, the DB management program 43 determines whether or not the patent information data stored in the HDD 30 includes the search options selected by the user in FIG. 7A or 7B.

For example, if the user selected US Patents, the keyword “video” and the technology classification code of G11B*, the DB management program 43 searches the HDD 30 for matching information (Step S45). If information in the HDD 30 matches information selected by the user (Yes in Step S45), the search results are displayed (Step S46). That is, the DB program 43 transfers the searched information data to the user's search terminal PC via the network interface 10 and displays the information to the user.

Then, the user can view the search results and determine if he or she wants to save the search terms and the search results (Step S47). If the user decides to save the search terms and results (Yes in Step S47), the search information is stored as a file (Step S48).

For example, with reference to FIG. 7B, the user has selected the following items to search for: (search destination=U.S. patent data) & (search word=video) & (search field)=G11B*). Therefore, the DB management program 43 searches the HDD 30 for information matching these fields. The search string is then moved to the search Query Window shown in the lower right corner of FIG. 7B. Thus, the user can then save the search string and the results of the search string by entering a file name and selecting the Store List button associated with the Search Query.

At this time, the region into which the data are stored is assigned a specific directory according to the user who logged in on the initial window of FIG. 5A or 5B. Therefore, when the same user logs in for a patent search, the user can retrieve a previous search string (and results of the search string) simply by entering the file name. In addition, the user can view a previously entered search string and then add another search condition.

For example, the user can add the search term “Digital”, and then the search engine 42 forms a new search string of (search destination=U.S. patent data) & (search word=video&digital) & (search field=G11B*) and the DB program 43 performs a new search using the new search string, so that it is possible to more quickly obtain a search result. The new search result information may then be saved with a new file name and stored on the HDD 30, so that the stored data may be used for another search in the future.

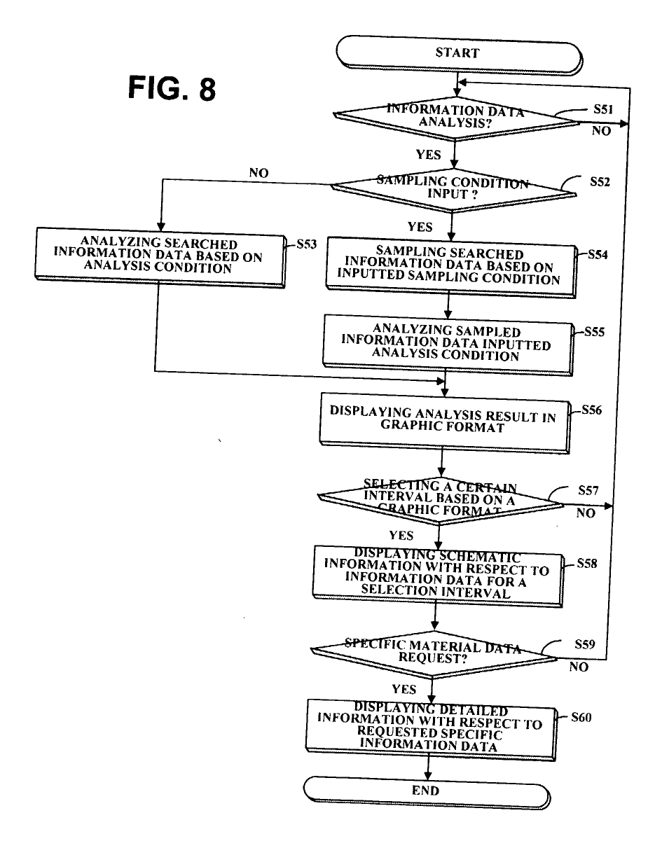

Next, FIG. 8 is a flowchart illustrating a method of analyzing patent information data according to an embodiment of the present invention. The analyzing method uses the data obtained according to the search conditions described above. FIG. 2 will also be referred to in this description.

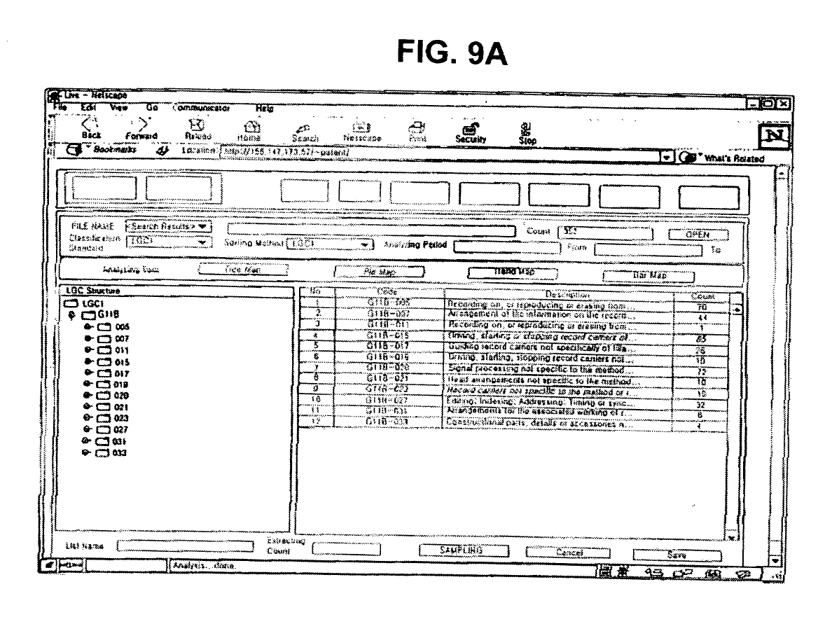

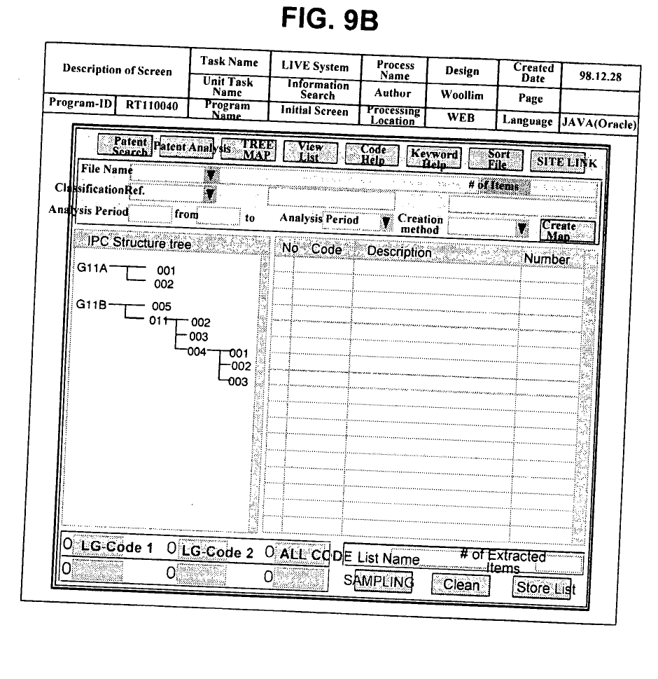

To analyze the data, the user first selects the Patent Analysis option shown in FIGS. 6A and 6B (Step S51). Thus, using this option, the user can analyze a technology trend or determine whether or not certain information is contained in the searched patent information. When the user selects the Patent Analysis option, a patent analysis menu window such as that shown in FIG. 9A or 9B is displayed to the user. As shown, the patent information is displayed in a form of a tree structure including a corresponding technical field code.

Then, using the patent analysis menu window, the user can input a sampling condition (Step S52) to request a sample when a large amount of patent information data is retrieved. That is, the search engine 42 preferentially samples the retrieved patent information data based on the sampling conditions input by the user (Step S54). Further, the analysis process is performed only with respect to the sample portion of the patent information data (Step S55).

For example, when there is a large volume of information data to be searched, the user may input a particular year as the sampling condition and input 5% as the sampling ratio. In another example, assuming there are 100 cases in 1981, 250 cases in 1982, 1221 cases in 1996, and 2% is the inputted sampling ratio. In this second example, two cases are randomly selected in 1981, five cases are randomly selected in 1982, and twenty-four cases are randomly selected in 1996. Then, the analysis process is performed with respect to the selected patent information data.

In addition, the sampling operation may be based on a specific year, technical field, etc. When the sampling operation is designated for each technical field, it is not necessary to randomly select 5%, for example, for each year. Namely, 5% for each technical field is selected.

The above Step S52 allows the user to sample a large amount of patent information data for analysis. However, if the user does not want to first sample the data, but rather wants to analyze all data related certain analysis conditions (No in Step S52), the user sets the analyzing conditions of the information data using the patent analysis menu window shown in FIG. 9A or 9B, for example. For example, the user can selectively input the technical classification code G11B and a 96-97 analysis period. Then, the analysis is performed with respect to the input analysis conditions among the searched patent information data (Step S53). Namely, the technical code of G11B as the technical classification code among the searched G111and G11B and the patent information data between the years of 96-97 is analyzed.

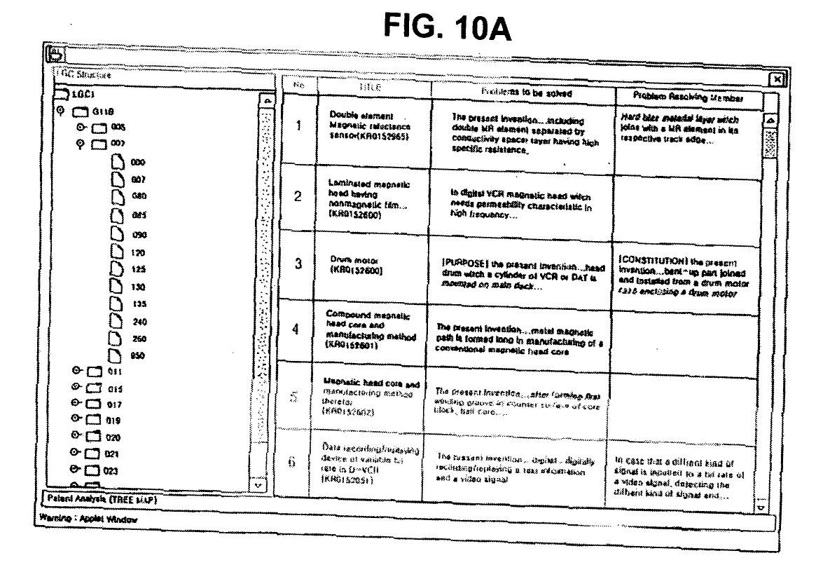

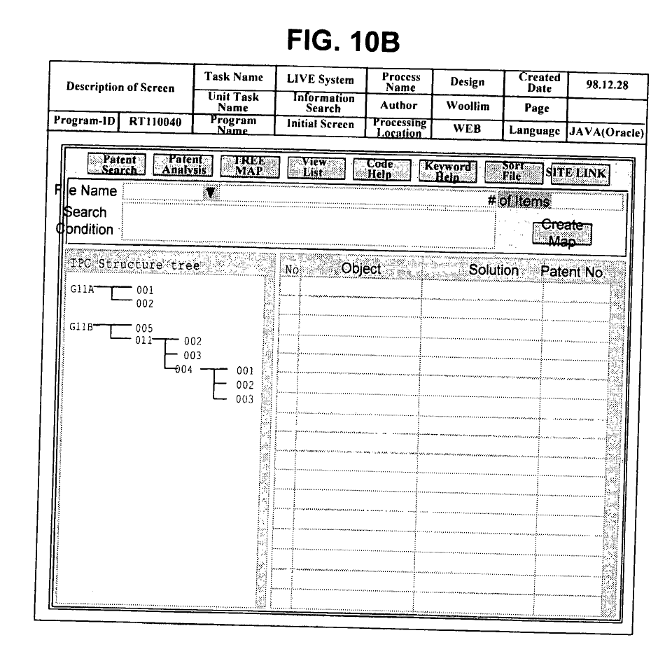

Then, the search engine 42 under control by the CPU 40 selects only the information data which satisfies the set analysis conditions. The search engine 42 forms a tree structure of the IPC code of the selected information data. Next, the search engine 42 transfers the information data to the user's search terminal PC via the network interface 10. The IPC codes of the information data is provided in a tree map form (e.g., displayed in a graphical format) (Step S56), which allows the user to access desired information in a stepwise manner. FIGS. 10A and 10B illustrate examples of such a graphical format.

In addition, with reference to FIG. 10B, if the user selects G11B and 011 among the IPC codes displayed on the window in the tree map form, and selects 004 among its sub-codes of 002, 003, 004, the search engine 42 selects only the patent information data of the technical field of G11B011/004. Next, the search engine 42 displays the problems to be overcome, the solutions, and the patent number contained in each patent information data to be sequentially displayed on the screen of the search terminal PC. FIG. 10A illustrates the title, Problems to be solved, and Problems solved based on a selection of particular IPC code. Thus, the user can accurately confirm the problems to be overcome, and the contents of the solutions in the patent information data of a certain technical field.

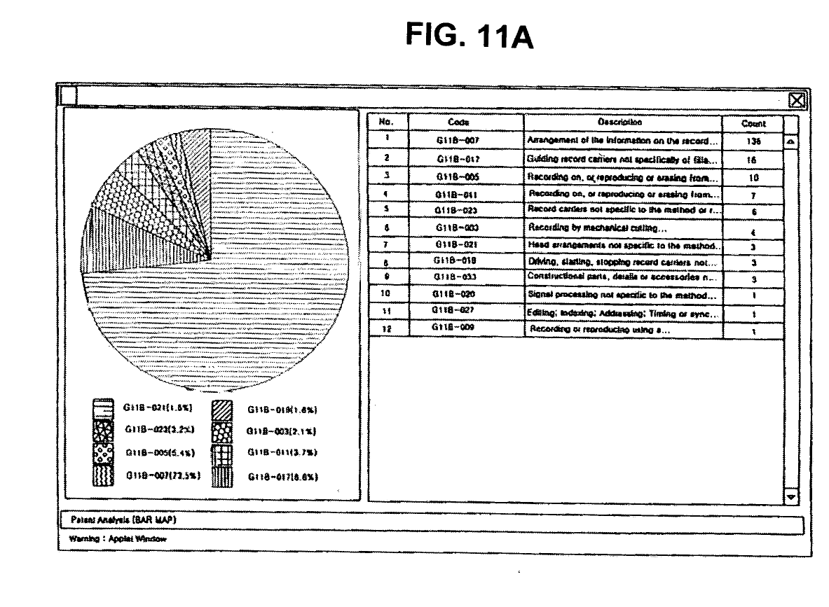

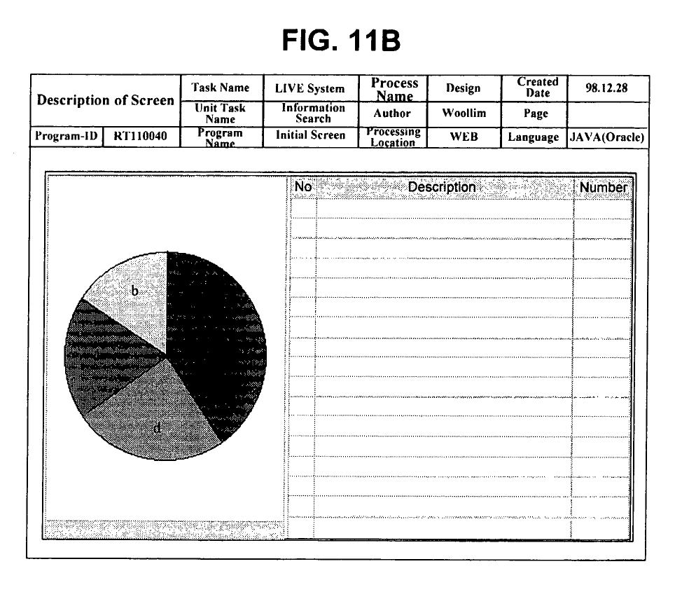

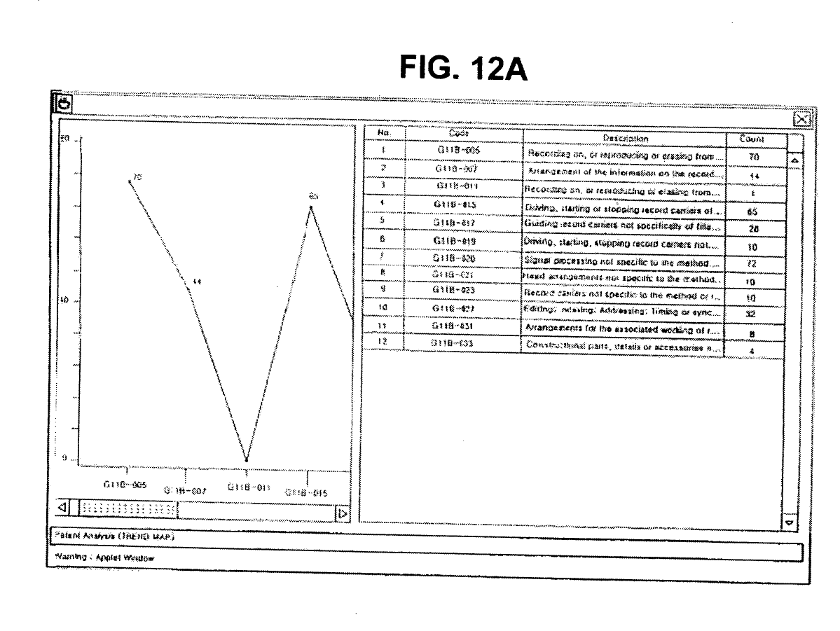

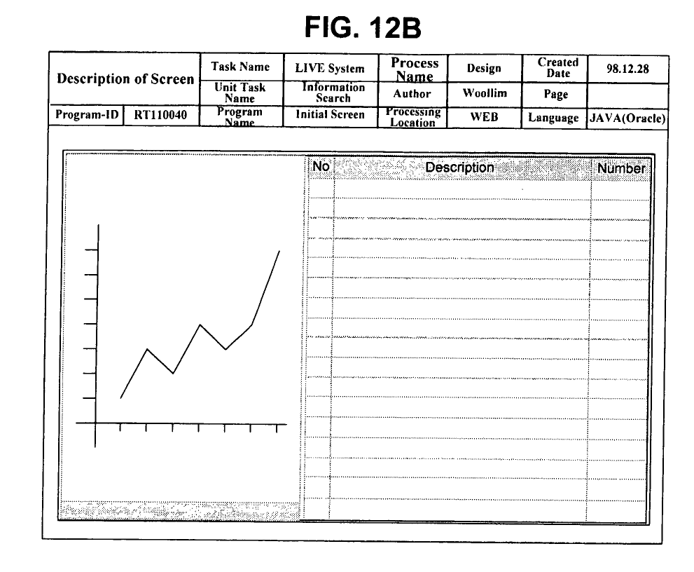

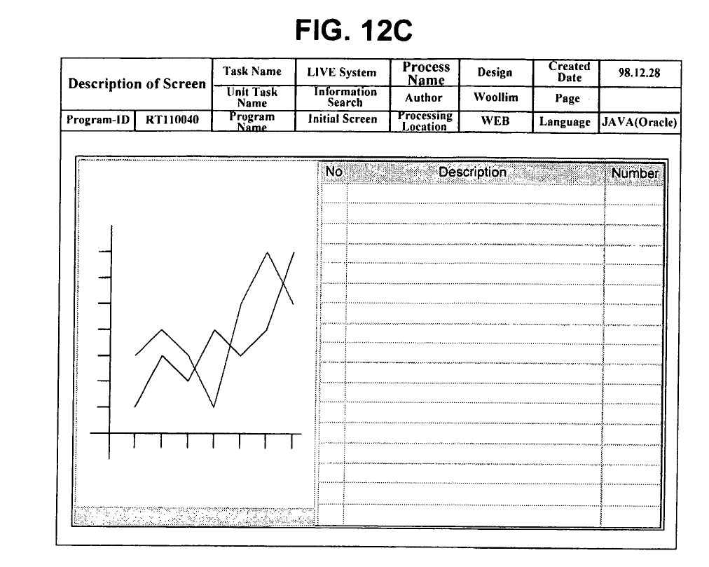

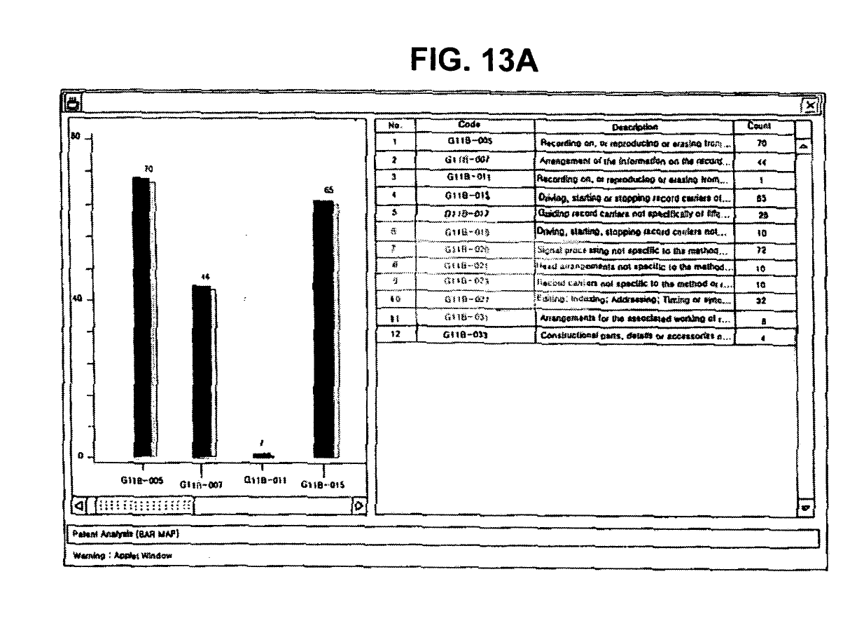

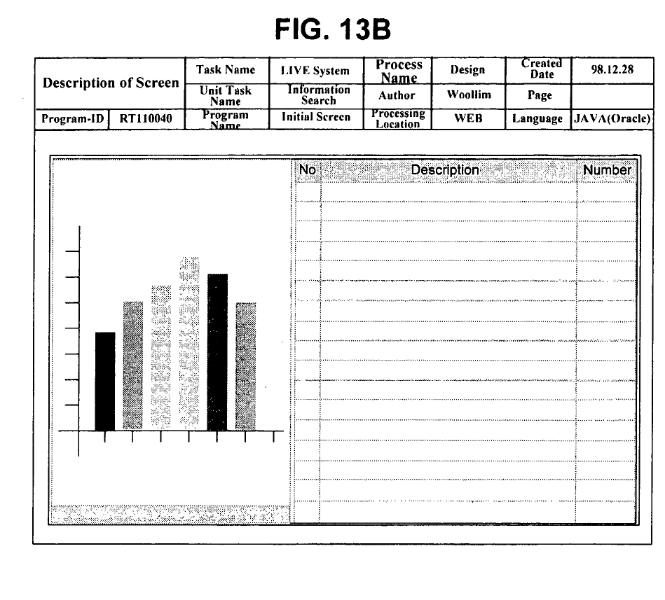

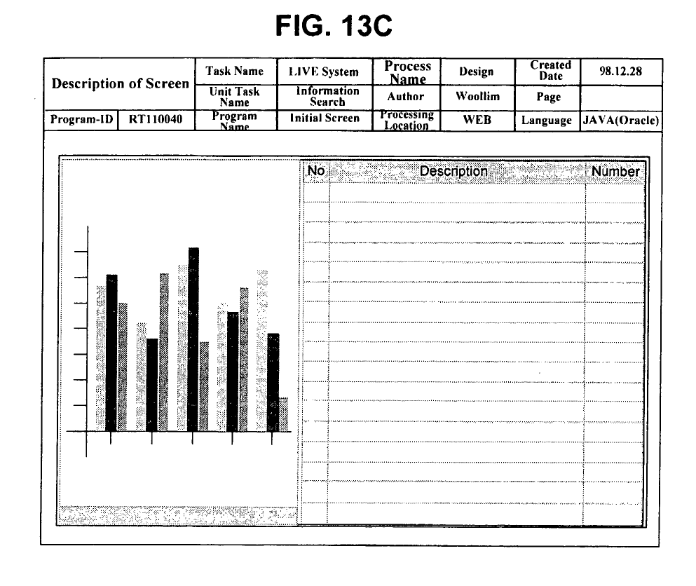

In addition, the analysis result may be displayed as a graphical form such as a pie chart (see FIGS. 11A and 11B), a trend graph (see FIGS. 12A-12C) or a bar map (see FIGS. 13A-13C). Namely, it is possible to implement various forms of graphic data.

In addition, with reference to FIG. 11A, each region or section of the pie chart is formed based on the ratio obtained in accordance with a corresponding technical field code of the patent information data. That is, FIG. 11A illustrates all sub codes for G11B. For example, the sections may correspond to a number of patents in each sub code. Thus, when viewing FIG. 11A, the user can readily determine that the sub code G11B-007 has the greatest number of patents. FIG. 11B illustrates a similar concept.

In addition, the ratios are statistical values of the analysis results information data. The analysis results may also be represented by the ratios of the respective numbers of items of lower technical field codes to the number of items of a currently selected higher technical field code where the number of items of the higher code is assumed to be 100%.

The search results may also be represented by the ratios of the respective numbers of items of technical fields at the same level in the tree as that of a currently selected technical field to the total number of items of the search results data where the total number of items of the search results data, regardless of the level of the currently selected technical field, is assumed to be 100%. For example, assume the user selects a sub-code “005” of an IPC code “G11B” from IPC codes in a tree map format, as shown in FIG. 9B, of the retrieved information.

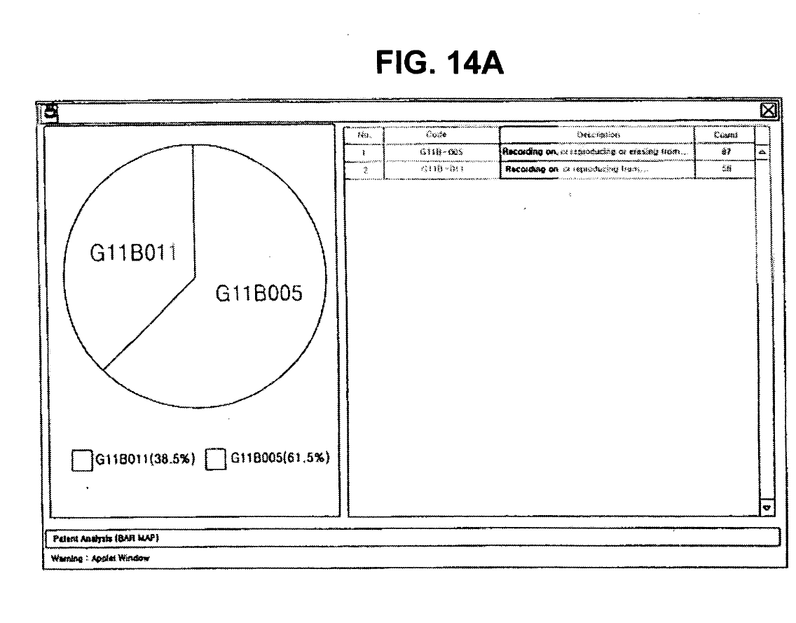

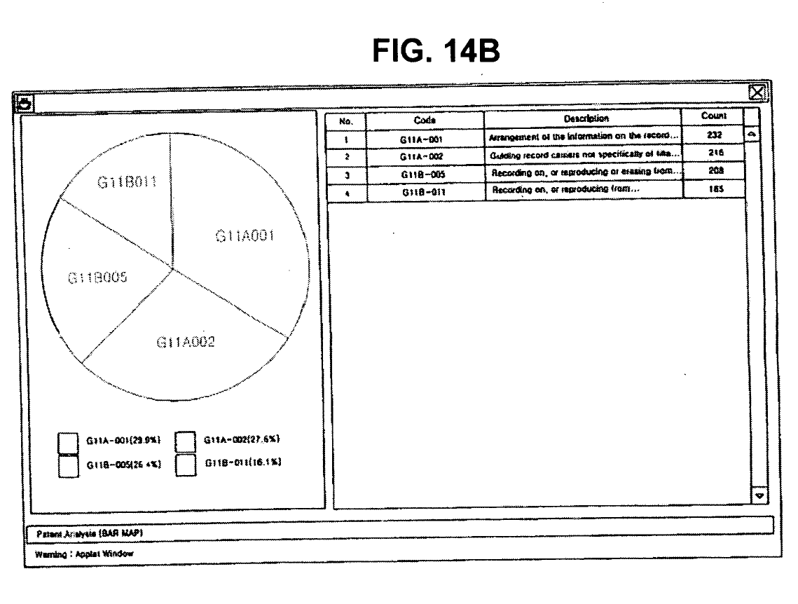

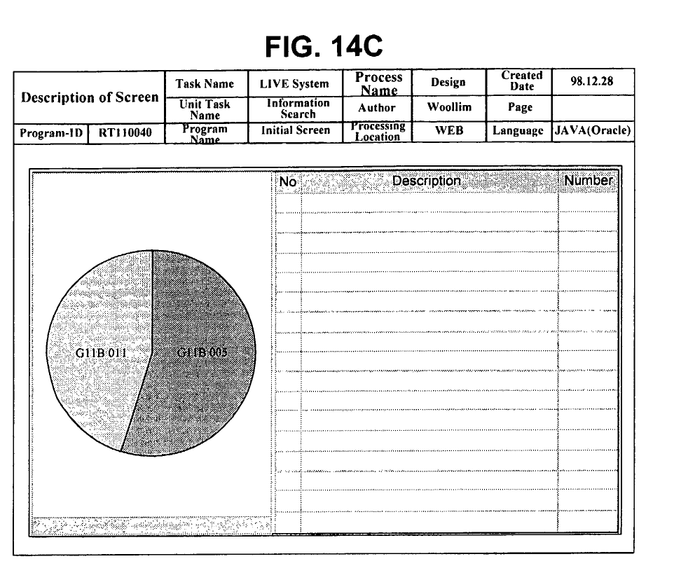

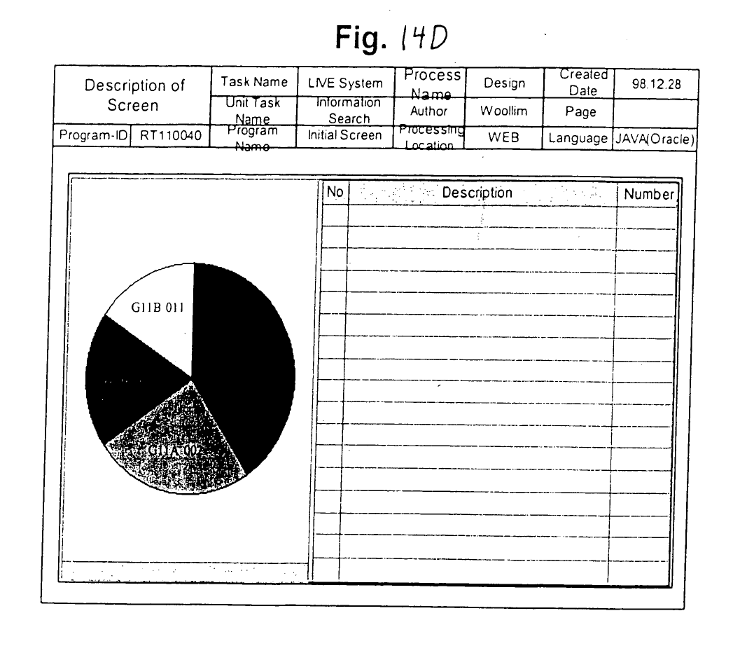

Thereafter, when the user requests that the analysis results of the retrieved information be displayed in a pie map format, the search engine 42 transmits and displays the analysis results in a pie map format as shown in FIG. 14C where the number of items of the technology classification code “G11B”, which is a higher code than the sub-code “005”, is assumed to be 100%. Alternatively, the search engine 42 may transmit and display, on the screen, the analysis results in a pie map format as shown in FIG. 14D where the number of items of all technology classification codes of the retrieved information, including not only sub-codes “005” and “011” of the selected technology classification code “G11B” but also sub-codes of a different technology classification code “G11A” at the same level as the sub-code “005” and “011” of “G11B” (i.e., “G11B 005”, “G11B 011”, “G11A 001”, and “G11A 002”), is assumed to be 100%. FIGS. 14A and 14B are similar to FIGS. 14C and 14D.

In addition, returning to FIG. 8, when the user selects a certain region (for example, a region in the pie charts of FIGS. 11A and 11B) (Step S57), the CPU 40, which controls the search engine 42, selects only the patent information data contained in the region among the searched patent information data. Next, the CPU 40 extracts the information (application date, applicant, the title of the invention, etc.) of the selected information data, transfers the information to the user's search terminal PC via the network interface 10, and displays the information (Step S58). By this arrangement, it is possible to easily confirm the information with respect to the information data contained in the selected interval or region based on the analysis result that the user provided in the graphic form.

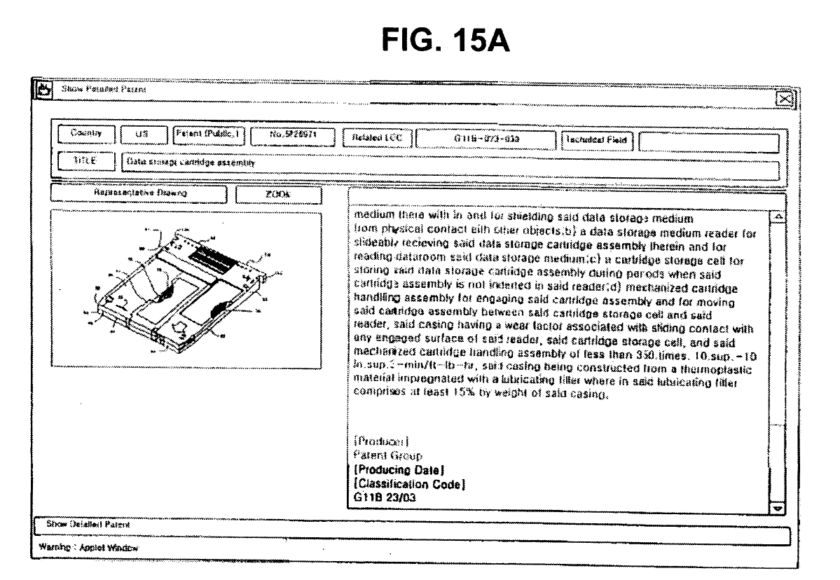

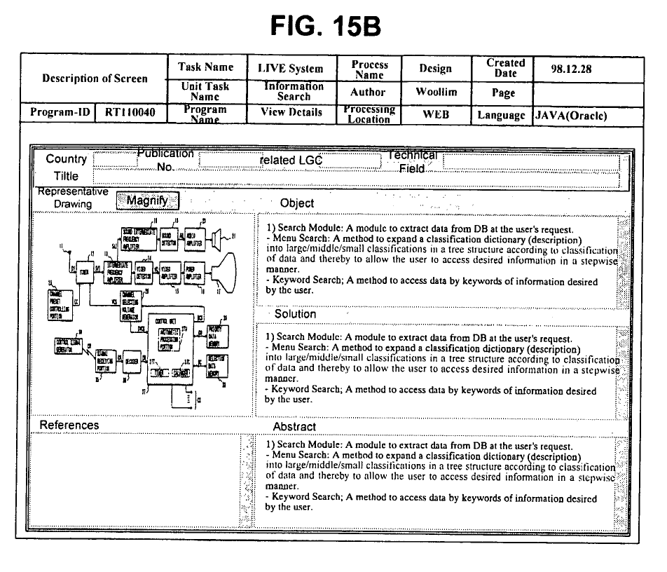

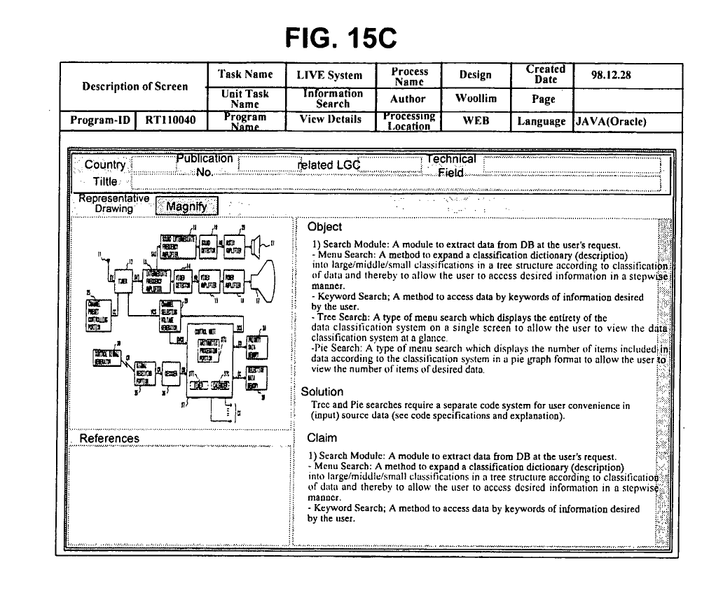

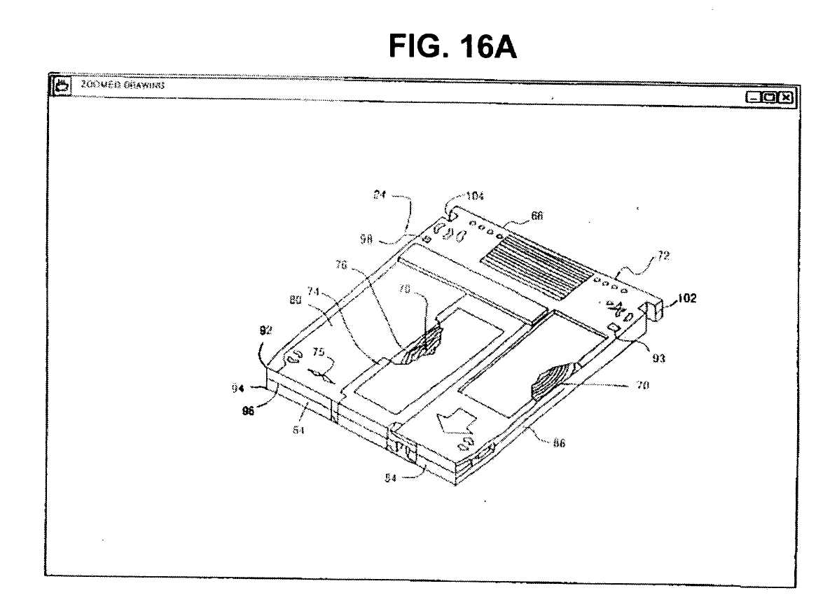

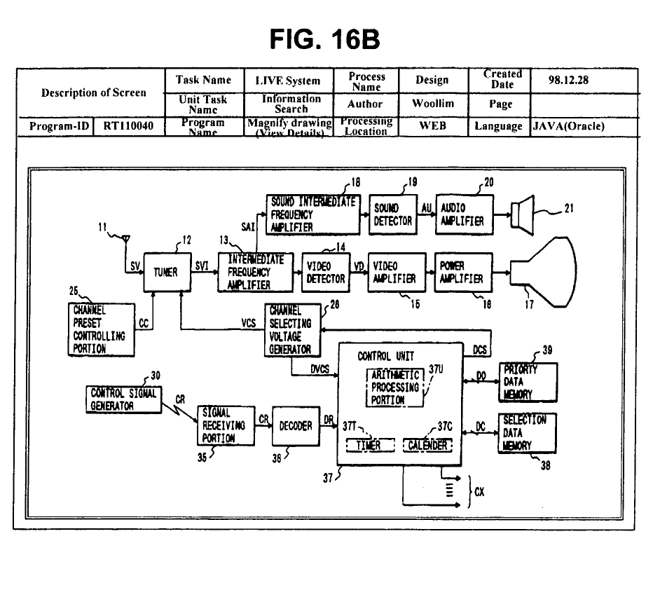

Further, the user may view summary information (see FIG. 10A, for example) and may request more detailed information (Step S59). In this instance, the CPU 40 extracts the requested information data among the searched information data and transfers the extracted data to the user's search terminal PC via the network interface 10. The more detailed information is then displayed to the user (Step S60). FIGS. 15A-15C illustrates examples of detailed information being displayed to the user. The user can also request a magnified view of the drawings by selecting a zoom or magnifying option. Then the enlarged drawings are displayed to the user as shown in FIGS. 16A and 16B.

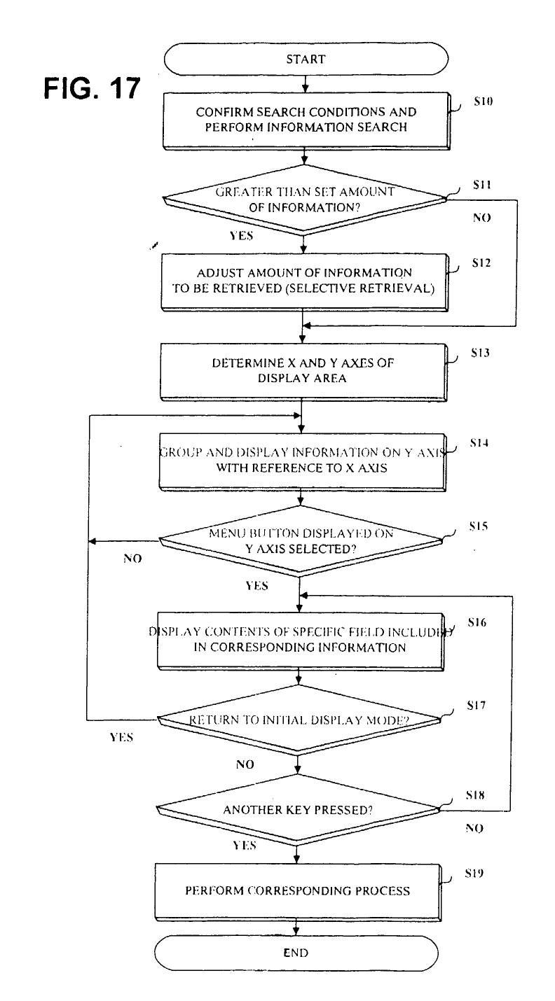

Turning now to FIG. 17, which is a flowchart illustrating a method for displaying search information according to an embodiment of the present invention. In the information search system to which the present invention is applied, the user accesses a variety of information sources selected and set by the user offline or online. For example, after the user accesses a database in which patent data is stored and then confirms search conditions selected and set by the user, patent information data, which satisfies the search conditions, is retrieved from the database (Step S10).

The user then checks the amount of the retrieved patent information data. When the amount of the retrieved patent information data exceeds a specified amount of information data (Yes in Step S11), for example, when the number of items (e.g., patents) of the initially retrieved patent data is 1000 and the number of information data items specified by the user is 100, the information search system performs a series of reselection processes to reduce the initially retrieved 1000 patent information items to 100 items (Step S12).

For example, if a range of application dates and an IPC code (IPC=H04*) are set as the search conditions, 4 groups of patent data, each including 25 patent data items, are selected and retrieved based on the application date of each patent data item so that a total of 100 patent data items are selected and retrieved. This search process may be performed based on other search conditions additionally set by the user.

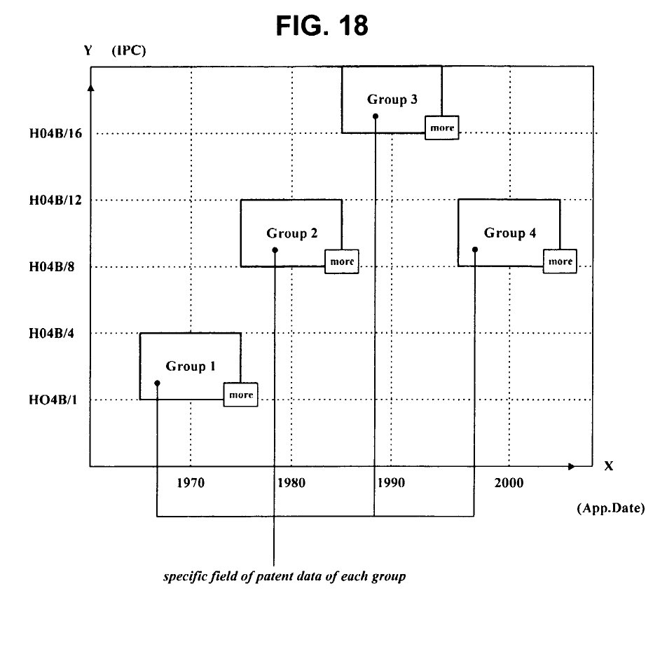

In addition, when a specific number of patent data items are selected and retrieved, the respective roles of X and Y axes of a display area, on which the patent data items are to be displayed, are determined (Step S13). For example, as shown in FIG. 18, the Y axis is defined as the IPC code and the Y axis is defined as the application date. The size of the display area is selected based on the information displayed on the X and Y axes. For example, the display area may be selected to display all information on the X and Y axes, or may be selected as a size greater than that.

In more detail, grouped information data items are displayed on the display area determined in the above manner. Further, all characters of the contents of each specific field included in the retrieved patent data are displayed so that the user can easily confirm the contents of the specific field. Alternatively, as shown in FIG. 18, some characters of the specific field can also be displayed in association with a menu button (for example, a “more” button) which can be selected by the user (Step S14).

When the user selects the menu button associated with a group (Step S15), a patent information item is retrieved from patent information items belonging to the group, and the contents of a specific field included in the retrieved patent information item are displayed on a large screen so that the user can confirm more detailed information of the specific field (Step S16).

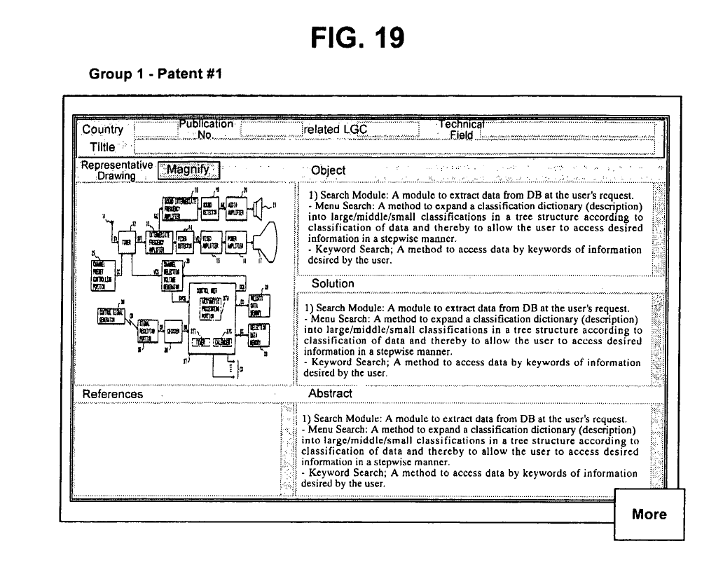

Thus, for example, as shown in FIG. 19, more detailed information of a first patent information item of the first group can be displayed, in conjunction with a representative drawing, on the screen of a computer currently used by the user. Thereafter, when the user presses a specific key to make a request to return to an initial display mode (Step S17), the information search system performs a series of operations for displaying an initial display screen based on the X and Y axes as described above with reference to FIG. 18.

When the user presses another key (Step S18), an operation corresponding to the pressed key is performed (Step S19). Using the information search system according to the present invention, the user can more efficiently confirm a large amount of information/data retrieved from an information source on a display area determined by the X and Y axes so that the user can easily and correctly analyze the overall trend and contents of related patents or the like.

Further, the X axis of the display area can be set to a different reference such as publication date, issue (or registration) date, or the like, depending on the user's selection, and the Y axis can be set to an arbitrary classification code edited by the user.

The information/data items, which are wholly displayed on the display area, can be printed at a much larger size than the A4 size through a large size printer typically used for AutoCad files or the like, and the information/data items can be displayed in a wider variety of formats on the display area.

As described above, in the search and analysis method for information data according to the present invention, the data are classified into problems to be overcome and the solutions for thereby providing information data. The thusly classified data are stored in a file format in connection with the search format of the data thereby implementing an easier access to the data. Further, it is possible to implement a quick search of the information data without repeatedly performing the data search. In addition, it is also possible to sample the search result information data to thereby significantly decrease the amount of the analysis information data, to thereby obtain a quick data analysis. Also, the analysis result of the information data may be provided on the screen in various graphic formats such as a pie chart, tree map, trend map, bar chart, etc., so the user can easily check the analysis result of the information data.

In addition, the present invention also provides an information search system and a method for displaying information retrieved by the information search system, wherein, after a variety of information sources such as patent data, article data, or technical data are accessed online or offline, information items satisfying search conditions are retrieved from the information source, and the retrieved information items are displayed on a display area of an arbitrary size with an X axis representing time such as application date and a Y axis representing a specific search condition such as International Patent Classification (IPC). Using the information search system, the user can efficiently confirm the retrieved information items on the display area with the X axis representing time and the Y axis representing a specific search condition, so that the user can easily and correctly analyze the overall trend and contents of related patents, technical information, or the like.

Although preferred embodiments of the present invention have been disclosed for illustrative purposes, those skilled in the art will appreciate that various modifications, additions and substitutions are possible, without departing from the scope and spirit of the invention as recited in the accompanying claims.

What is claimed is:

1. A method for searching information, the method comprising:
a) accessing an information source online or offline, the information source including a number of plurality of selectable fields;
b) selecting and extracting specific fields that satisfy a search condition from the information source; and
c) grouping and displaying contents of the extracted specific fields with reference to time on an X axis and technology classification on a Y axis.

2. The method according to claim 1, wherein the information source is a database or a recording medium in which at least one of patent data, article data, and technical data is stored and managed.

3. The method according to claim 2, wherein the recording medium is inserted into a computer and the database is accessed via a network.

4. The method according to claim 1, wherein the search condition is at least one of a specific code, date information, bibliographic information, and the amount of data to be retrieved, which are selected and set by a user.

5. The method according to claim 4, wherein a number of the extracted specific fields is limited to the amount of data to be retrieved.

6. The method according to claim 1, wherein the step c) displays the grouped contents of the extracted specific fields on a display area variably determined by the X and Y axes.

7. The method according to claim 6, wherein the time on the X axis is determined based on one of application date, publication date, and issue date of patent data.

8. The method according to claim 6, wherein the technology classification on the Y axis is an International Patent Classification (IPC) code of patent data or a specific classification code arbitrarily edited by a user.

9. The method according to claim 6, wherein an entire size of the display area determined by the X and Y axes is equal to or greater than a size needed to display all fields on a computer monitor screen.

10. The method according to claim 6, wherein all characters of the grouped contents of the specific fields are displayed or some characters thereof are displayed in association with a menu button that can be selected by a user to view additional characters not displayed.

11. An information search system, comprising:
an accessing mechanism configured to access an information source online or offline, the information source including a number of plurality of selectable fields;
a selecting and extracting mechanism configured to select and extract specific fields that satisfy a search condition from the information source; and
a grouping and displaying mechanism configured to group and display contents of the extracted specific fields with reference to time on an X axis and technology classification on a Y axis.

12. The system according to claim 11, wherein the information source is a database or a recording medium in which at least one of patent data, article data, and technical data is stored and managed.

13. The system according to claim 12, wherein the recording medium is inserted into a computer and the database is accessed via a network.

14. The system according to claim 11, wherein the search condition is at least one of a specific code, date information, bibliographic information, and the amount of data to be retrieved, which are selected and set by a user.

15. The system according to claim 14, wherein a number of the extracted specific fields is limited to the amount of data to be retrieved.

16. The system according to claim 11, wherein the grouping and displaying mechanism displays the grouped contents of the extracted specific fields on a display area variably determined by the X and Y axes.

17. The system according to claim 16, wherein the time on the X axis is determined based on one of application date, publication date, and issue date of patent data.

18. The system according to claim 16, wherein the technology classification on the Y axis is an International Patent Classification (IPC) code of patent data or a specific classification code arbitrarily edited by a user.

19. The system according to claim 16, wherein an entire size of the display area determined by the X and Y axes is equal to or greater than a size needed to display all fields on a computer monitor screen.

20. The system according to claim 16, wherein all characters of the grouped contents of the specific fields are displayed or some characters thereof are displayed in association with a menu button that can be selected by a user to view additional characters not displayed.
